(19) United States
(12) Patent Application Publication
(10) Pub. No.: US 2004/0043291 A1
(43) Pub. Date: Mar. 4, 2004

(54) Cathode containing muticomponent binder mixture and lithium-sulfur battery using the same

(76) Inventors: Nam In Kim, Kwangju (KR); Chae Bong Lee, Kwangju (KR); Won Jae Lee, kyungkido (KR); Young Bae Roh, Kwangju (KR)

Correspondence Address: JACOBSON, PRICE, HOLMAN & STERN, PROFESSIONAL LIMITED LIABILITY COMPANY, 400 SEVENTH STREET N.W., WASHINGTON, DC, 20004, US

(21) Appl. No.: 10/233,755

(22) Filed: Sep. 4, 2002

(51) Int. Cl. H01M 4/62; H01M 4/04

(52) U.S. Cl. 429/217; 429/232; 29/623.1

(57) ABSTRACT

Disclosed herein are a lithium-sulfur battery and a method of manufacturing the same, whose cathode is manufactured by adding a binder mixture of two or more materials so as to develop pores within a cathode plate, so that does not exhibit shortcomings, including deterioration in cycle life characteristic, electrolyte leakage, deposition of lithium sulfide (Li₂S) and a reduction in discharge capacity at high rate discharge. More specifically, disclosed herein is a cathode for lithium-sulfur batteries and a method of manufacturing the same, which is manufactured using a multicomponent binder mixture consisting of polytetrafluoroethylene and a thickener. Also, disclosed herein are a lithium-sulfur battery and a method of manufacturing the same, which is manufactured using the above cathode so as to develop pores within the electrode plate, so that the battery exhibits the extended cycle life, the non-leakage of electrolytes and the improved discharge capacity at high rate discharge.

### BACKGROUND OF THE INVENTION

1. Field of the Invention

The present invention relates to a lithium-sulfur battery whose cathode is manufactured using a multicomponent mixture consisting of polytetrafluoroethylene mixed with a thickener as a binder, so that the battery does not exhibit shortcomings, including deterioration in cycle life characteristic, leakage of electrolytes and a reduction in discharge capacity at high rate discharge.

2. Background of the Related Art

A battery originally means a device which transforms chemical energy generated in electrochemical oxidation-reduction reaction of chemical substances contained therein into electrical energy. According to characteristics on the use thereof, it can be divided into a primary battery which must be wasted when energy within the battery is exhausted, and a rechargeable battery which can be re-used several times with continuous charge.

Recently, owing to rapid development of electronic, telecommunication and computer industries, the use of portable electronic products, including a camcorder, a portable telephone and a notebook PC, is popularized with tendency toward small-size, light-weight and high-capacity. Thus, there is an urgent demand for small-size, light-weight and high-capacity batteries which have high reliability and long cycle life.

Furthermore, as an innovative change in information telecommunication industries is expected by appearance of the IMT-2000 service which is called “third generation mobile telecommunication”, technologies of the telecommunication field will be more rapidly developed. In this circumstance, along with an increase in content and amount of services to be provided, the amount of energy required for operation of terminals also needs to be more increased. This is because services provided in IMT-2000, including image transmission, require much energy, and thus the technical view of the rechargeable battery which is an electric power source required for the services shows tendency toward small-size, light-weight and high-capacity.

Research and development of the rechargeable battery in an attempt to satisfy such demands in the telecommunication-associated technology have been continuously conducted. The rechargeable battery, which is highly interested and highlighted in response to such demands, is exactly the lithium secondary battery.

Since lithium is lightest among metals on the earth, it has the highest electrical capacity per unit mass. Also, it has a high thermodynamic oxidation potential value so that it is a material which enables manufacture of a high-voltage battery. For these reasons, it is recently most preferably selected as a material for a battery which can generate maximum energy using a limited amount of chemical energy, particularly for the rechargeable battery.

The lithium-ion secondary battery comprises lithium-metal oxide permitting deintercalation and intercalation of lithium ion, as a cathode active material. Also, it comprises a carbon material or metal-lithium, etc. as an anode, and an electrolyte consisting of a suitable amount of lithium salt electrolytes dissolved in an organic solvent mixture. This is advantageous in that it has an energy density per weight corresponding to about 200% of a Nicad battery and about 160% of a nickel-hydrogen battery, and an energy density per unit density corresponding to about 170% of the Nicad battery and about 105% of the nickel-hydrogen battery. Furthermore, it has a low self-discharge rate of less than 5%/month at 20° C. which corresponds to one-third of the Nicad or nickel-hydrogen battery. Also, it is environment-friendly since it does not use environment-polluting heavy metals, such as cadmium and mercury. In addition, it has an advantage in that it can repeat charge and discharge 500 times or more in normal condition, and thus has a long cycle life.

Furthermore, the lithium ion battery generally has an average discharge voltage of 3.6 to 3.7 V which can be regarded as the most important advantage enabling generation of higher voltage than other alkali batteries, Ni-MH or Ni-Cd batteries.

Meanwhile, among such lithium secondary batteries, the lithium-sulfur battery which utilizes sulfur as an electrode active material has excellent energy density characteristic and inexpensive active material costs and is environment-friendly. Thus, it is recently actively researched and developed as a substitute for the lithium ion battery which is the recent general lithium secondary battery.

However, the lithium-sulfur batteries having such various advantages are not in common use as yet. This is because availability of sulfur in the lithium-sulfur batteries developed up to date is very low due to a low conductivity of sulfur. Namely, the ratio of the amount of sulfur participated in actual oxidation-reduction reaction within the batteries to the amount of sulfur used as the cathode active material is very low.

Moreover, when sulfur is used as the cathode active material, it is disadvantageous in that sulfur is dissolved and leaked into an electrolyte, or subjected to the lithium reaction in the form of polysulfide according to the kind of an electrolyte, or advanced into the form of lithium sulfide (Li₂S), so that it can no longer participate in the battery reaction, thereby deteriorating the battery cycle life.

In addition, due to the problems as described above, the existing lithium-sulfur batteries also had a fatal disadvantage in that it exhibits a reduced discharge capacity at high rate discharge.

In the prior arts of such lithium-sulfur batteries which have been developed up to date, U.S. Pat. No. 6,344,293 discloses an attempt to extend cycle life of a lithium-sulfur battery having a cathode comprising a sulfur-containing material by adding water as a substitute for a non-aqueous electrolyte. Also, U.S. Pat. No. 5,506,072 discloses an attempt to improve cycle life and performance of a battery having a cathode comprising a sulfur-containing material by adding a buffering agent and a complexing agent.

Furthermore, unlike the attempts to improve cycle life or performance of the lithium-sulfur battery with such proper additives, U.S. Pat. No. 6,329,789 discloses a method of recharging a lithium-sulfur battery having a cathode comprising a sulfur-containing material to improve cycle life of the battery.

However, in such lithium-sulfur batteries developed up to date, the above-mentioned disadvantages of the existing lithium-sulfur batteries, i.e., low sulfur availability, dissolution and leakage of sulfur into an electrolyte, and deposition of lithium sulfide (Li₂S), are not obviated. Thus, these batteries still have disadvantages, including deterioration in battery cycle life, low battery stability and a reduction in discharge capacity at high rate discharge. This can be proved from a point that there is no lithium-sulfur battery which has been in common use.

Meanwhile, binders for binding of a cathode mixture, which have been used in the lithium secondary battery, include polyethylene oxide, polyvinylidene fluoride (PVdF)-based compounds and polyvinylpyrrolidone. This binder has problems in view of electrolyte resistance and electrochemical resistance, or the batteries using these binders exhibit insufficient formation of pores within the resulting cathode plate. Thus, they exhibit various disadvantages, including low sulfur availability and a reduction in discharge capacity at high rate discharge, and in these batteries, the choice of electrolytes is narrowly limited. Particularly, when highly viscose electrolytes are used, there is a disadvantage in that these electrolytes are difficult to be penetrated into an electrode plate so that sulfur compound availability is reduced and the high rate discharge characteristic is deteriorated. In addition, as a material of which use is searched because of its excellent binder property, there is polytetrafluoroethylene. However, this material has problems in that it is difficult to maintain a desired viscosity in producing the cathode slurry and has an insufficient moldability. For this reason, the use of this material is not realized.

### SUMMARY OF THE INVENTION

Accordingly, an object of the present invention is to solve the problems of the prior art as described above and to provide a cathode for a lithium secondary battery, which obviate various shortcomings of the lithium-sulfur battery according to the prior art, including low sulfur availability, dissolution and leakage of sulfur into electrolytes, deposition of lithium sulfide (Li₂S) and a reduction in discharge capacity at high rate discharge, and a shortcoming that, when the existing binder is used for the manufacture of a cathode plate, pore formation within the manufactured cathode plate is insufficient such that the choice of an electrolyte is narrowly limited, and also a shortcoming that, when a highly viscose electrolyte is used, it is difficult for the electrolyte to be penetrated into an electrode plate so that sulfur compound availability is reduced and a high rate discharge characteristic is deteriorated.

Another object of the present invention is to provide a method of manufacturing the above cathode.

Another object of the present invention is to provide a lithium-sulfur battery using the above cathode.

An object of the present invention is to provide a method of manufacturing a lithium-sulfur battery using the above cathode.

To achieve this objects and other advantages and in accordance with the purpose of the invention, the present invention provides a cathode manufactured using a multicomponent mixture where a thickener is mixed with polytetrafluoroethylene at the desired ratio. In the prior art, such a polytetrafluoroethylene was difficult to be used as a binder because it has problems in that it is difficult to maintain a desired viscosity in manufacturing a cathode slurry and has an insufficient moldability.

Another aspect of the present invention provides a lithium-sulfur battery comprising the above cathode.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a graph showing sulfur availability according to voltage in a lithium-sulfur battery manufactured by Example 1 of the present invention;

FIG. 2 is a graph showing sulfur availability according to voltage in a lithium-sulfur battery manufactured by Example 2 of the present invention;

FIG. 3 is a graph showing sulfur availability according to voltage in a lithium-sulfur battery manufactured by Comparative Example 1;

FIG. 4 is a graph showing a change in discharge capacity according to discharge rate in a lithium-sulfur battery manufactured by Example 1 of the present invention;

FIG. 5 is a graph showing a change in discharge capacity according to discharge rate in a lithium-sulfur battery manufactured by Comparative Example 1;

FIG. 6 is a graph showing a change in specific surface area of cathode mixtures produced by Examples 1 and 2 and Comparative Example 1; and

FIG. 7 is a graph showing the pore distribution of cathode mixtures produced by Examples 1 and 2 and Comparative Example 1.

### DETAILED DESCRIPTION OF THE PREFERRED EMBODIMENT

Reference will now be made in detail to the preferred embodiments of the present invention.

The present invention relates to a lithium-sulfur battery whose cathode is manufactured using a mixture of two or more materials as a binder, so that the shortcomings, including deterioration in cycle life, electrolyte leakage, deposition of lithium sulfide (Li₂S) and a reduction in discharge capacity at high rate discharge, are obviated.

More specifically, the present invention relates to a cathode for use in a lithium-sulfur battery, which is manufactured using a binder mixture consisting of a thickener mixed with polytetrafluoroethylene, and also to a method of manufacturing the same. Moreover, it relates to a lithium-sulfur battery, which is manufactured using the above cathode, so that battery cycle life is extended, an electrolyte is not leaked and discharge capacity at high rate discharge is increased, and also to a method of manufacturing the lithium-sulfur battery.

The thickener which can be used in the practice of the present invention is one or more selected from the group consisting of carboxymethyl cellulose, polyvinyl alcohol, polyvinyl acetate, polyethylene oxide, polyacrylonitrile, polyvinyl pyrrolidone, alkylated polyethylene oxide, polyvinyl pyridine, crosslinked polyethylene oxide, polyvinyl ether, polymethyl methacrylate, polyvinylidene fluoride, copolymer of polyhexafluoropropylene and polyvinylidene fluoride, polyethylacrylate, polyvinyl chloride, and polystyrene. Among these thickeners, carboxymethyl cellulose or polyvinyl alcohol is preferably used.

In the present invention, the thickener is mixed with polytetrafluoroethylene, a binder, to produce a binder mixture which is used as a binder material in manufacturing the cathode. This thickener has electrochemical resistance and electrolyte resistance, and develops pores within an electrode so as to provide a wide area for reaction while reducing internal resistance of the battery. Thus, it serves to increase sulfur availability and to extend battery cycle life and also to improve high rate discharge characteristic.

When polytetrafluoroethylene which is used in the present invention is used in combination with a thickener of the desired viscosity, such as carboxymethyl cellulose or polyvinyl alcohol, it exhibits good electrolyte resistance and develops pores within the electrode plate, so that it makes the moisturizing action of the electrolyte easy and is effective in reducing the internal resistance of the battery.

Carboxymethyl cellulose or polyvinyl alcohol which is preferably used as a thickener in the present invention makes a cathode binder property of polytetrafluoroethylene excellent. At the same time, it also serves to maintain the desired viscosity when applying cathode slurry on aluminum foil in manufacturing a cathode, and is effective in reducing contact resistance between the aluminum foil and the cathode active material.

As described above, the binder mixture is produced using the viscose thickener along with polytetrafluoroethylene and is used for the manufacture of the cathode for the lithium-sulfur battery. For this reason, it is believed that the choice of an electrolyte for the lithium-sulfur battery according to the present invention varies widely.

In the present invention, conductive carbon black is used together with sulfur as a cathode material, and metallic lithium is used as an anode material. A porous polyethylene sheet is used as a separator. A method of manufacturing the battery cathode using such materials together with the binder mixture, and a method of manufacturing the lithium-sulfur battery using the cathode will now be described.

First, 20 to 80% by weight of sulfur and 10 to 50% by weight of carbon black relative to a cathode mixture for the manufacture of a cathode are mixed with each other and then crushed for 20 to 30 hours using a ball mill.

Also, a thickener is dissolved in a solvent mixture of water/ethanol (volume ratio of 9:1) in such a manner that the amount of the thickener is 0.1 to 20% by weight relative to the cathode mixture. To the resulting solution, a polytetrafluoroethylene emulsion (Asahi Glass Fluoropolymers Co., AD1; solid content of 60% by weight) is added at the amount of 0.1 to 20% by weight relative to the cathode mixture so as to produce a binder solution.

Thereafter, a water/ethanol solution (volume ratio of 9:1) is introduced into the sulfur and carbon black powders at the ratio of 176 g of powder per 200 g of solution, to which the binder solution is added. The resulting mixture is stirred so as to produce a cathode mixture slurry for the manufacture of the cathode. In this case, it is preferred that polytetrafluorethylene is used at the amount of 10 to 18% by weight relative to the final cathode plate, and the thickener is used at the amount of 2 to 10% by weight relative to the final cathode plate.

Then, the cathode mixture slurry is crushed for 10 to 15 hours using a ball mill. Next, the crushed slurry is uniformly applied on both sides of aluminum foil to a thickness of 5 to 60 μm and vacuum-dried at a temperature of 50 to 70° C. for 10 to 15 hours, thereby manufacturing a cathode plate.

The cathode plate thus manufactured is slitted to have a suitable size and wound in the form of a jellyroll, together with an anode plate made of metallic lithium and a polyethylene sheet as a separator. Next, it is mounted in a battery case which is then filled with an electrolyte, thereby assembling a battery.

The electrolyte which is used in the present invention is selected from a solution of 1M LiN(SO₂CF₃)₂ in tetraethylenen glycol dimethylether/1,3-dioxolane (1:1), a solution of 1M LiN(SO₂CF₃)₂ in tetraethylenen glycol dimethylether/1,3-dioxolane (3:7), a solution of 1M LiN(SO₂CF₃)₂ in dimethoxyethane/sulfolane/1,3-dioxolane (3:1:1), and a solution of 1M LiSO₃CF₃ in dimethoxyethane/sulfolane/1,3-dioxolane (3:1:1).

The present invention will hereinafter be described in further detail by examples. It should however be borne in mind that the present invention is not limited to or by the examples.

### EXAMPLE 1

Using the following composition and manufacturing method, a cathode was manufactured as Example 1 of the present invention, and four kinds of batteries which have the different electrolyte, respectively, were manufactured.

First, 116 g of sulfur and 60 g of carbon black for the manufacture of a cathode are mixed in a high-speed mixer, and then crushed for 24 hours using a ball mill.

4 g of carboxylmethyl cellulose is dissolved in 200 g of a solvent mixture of water/ethanol (volume ratio of 9:1), to which 67.5 g of a polytetrafluoroethylene emulsion (Asahi Glass Fluoropolymers Co., AD1; solid content of 60% by weight) is then added, thereby producing a binder solution.

Thereafter, 200 g of a water/ethanol solution (volume ratio of 9:1) is introduced into the sulfur and carbon black powders, to which 272 g of the produced binder solution is then added. The resulting mixture is stirred, thereby producing a cathode mixture slurry for the manufacture of a cathode.

Next, the resulting cathode mixture slurry is crushed for 12 hours using a ball mill. Following this, the crushed slurry is uniformly applied on both sides of aluminum foil to a thickness of 50 μm and vacuum-dried at 60° C. for 12 hours, thereby manufacturing a cathode plate.

The cathode plate thus manufactured is slitted to have a size of 20.1×2.1 cm and wound in the form of a jellyroll together with an anode plate made of metallic lithium and a polyethylene sheet as a separator. Next, it is mounted in a battery case which is then filled with an electrolyte, thereby assembling a battery.

In this Example, four kinds of batteries were manufactured using four kinds of electrolytes indicated in Table 1 below.

TABLE 1
Composition of Electrolyte

| Electrolyte | Composition |
|---|---|
| Electrolyte 1 | 1 M LiN(SO₂CF₃)₂ in |
| | tetraethylenen glycol dimethylether/1,3-dioxolane |
| | (1:1) |
| Electrolyte 2 | 1 M LiN(SO₂CF₃)₂ in |
| | tetraethylenen glycol dimethylether/1,3-dioxolane |
| | (3:7) |
| Electrolyte 3 | 1 M LiN(SO₂CF₃)₂ in |
| | dimethoxyethane/sulfolane/1,3-dioxolane (3:1:1) |
| Electrolyte 4 | 1 M LiSO₃CF₃ in |
| | dimethoxyethane/sulfolane/1,3-dioxolane (3:1:1) |

### EXAMPLE 2

A cathode was manufactured in the same manner as Example 1, except that 22 g of polyvinyl alcohol instead of carboxylmethyl cellulose as a thickener and 37 g of a polytetrafluorethylene emulsion were used. Also, a battery was assembled using Electrolyte 1 indicated in Table 1 above.

### Comparative Example 1

A cathode was manufactured in the same manner as Example 1, except that polyvinylpyrrolidone (M/W: 360,000) instead of the polytetrafluorethylene emulsion as a binder was used at the amount of 10% by weight relative to the cathode mixture and a thickener was not used. Also, two kinds of batteries were assembled using Electrolytes 1 and 4 indicated in Table 1. In this case, polyvinylpyrrolidone was used in a state where it was dissolved in N,N-dimethylformamide (DMF).

### Test Example 1

Using the batteries of Examples and Comparative Example manufactured as described above, sulfur availability according to a change in voltage was tested.

The tests were carried out by leaving the batteries of Examples and Comparative Example to stand for 2 days at room temperature and then discharging at a current rate of 0.083 mA/cm² using a charger/discharger. Results were obtained by measuring the actual capacity (mAh/g) versus the theoretical capacity expected from the amount of used sulfur.

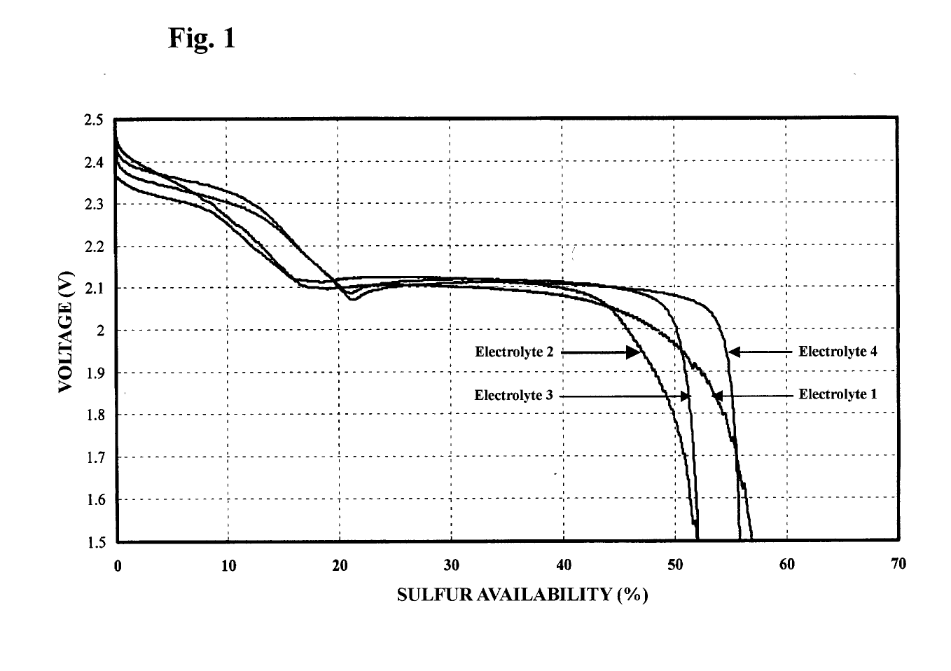

The tests were carried out for Examples 1 and 2 and Comparative Example 1. Results are shown in FIGS. 1 to 3, respectively.

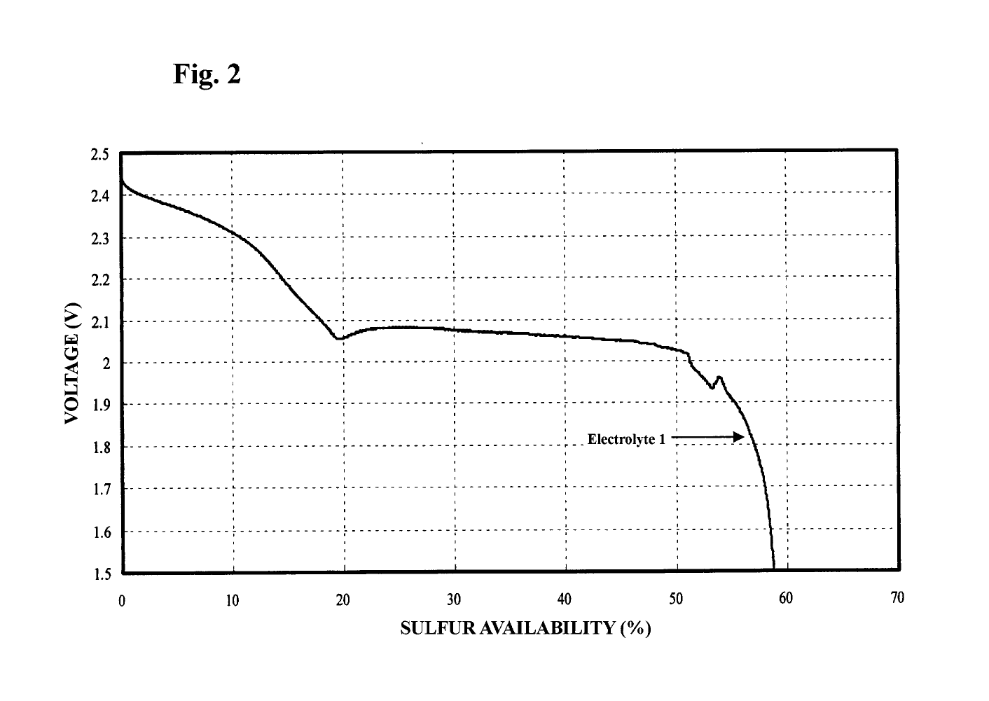

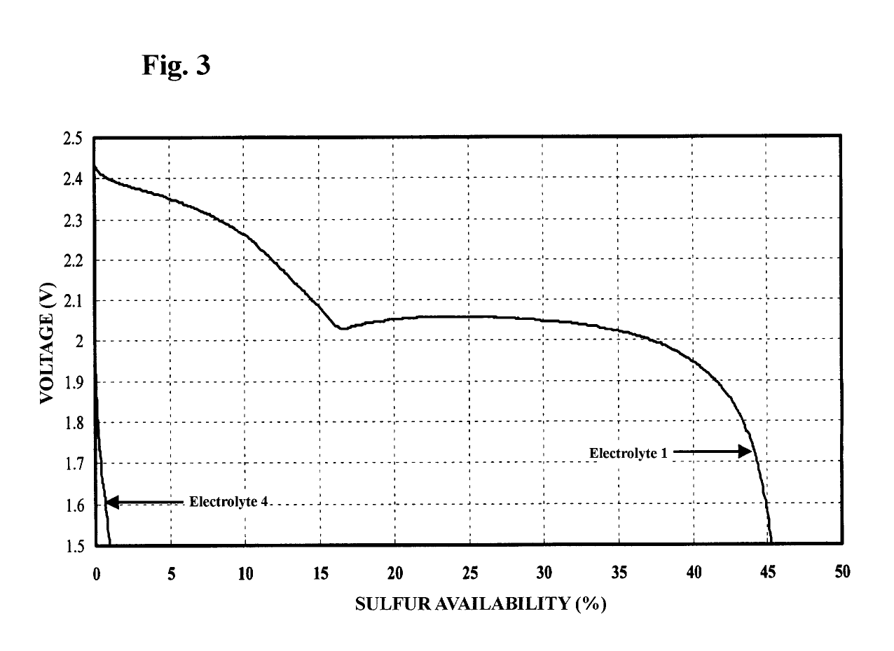

From the results of FIG. 1, it can be found that the battery using the cathode manufactured by Example 1 exhibits a sulfur availability of more than 50% which indicates a very excellent discharge characteristic. From FIG. 2 showing the result of the test using the battery of Example 2, it can be found that, even when polyvinyl alcohol instead of carboxylmethyl cellulose is used as the thickener, the battery exhibits a high sulfur availability of about 58% and thus has good performance. However, from FIG. 3 showing the results of the test using the battery manufactured according to Comparative Example 1, it can be found that the battery using Electrolyte 4 exhibits a sulfur availability of about 0.7%, and the battery using Electrolyte 1 exhibits a sulfur availability of about 45% which is significantly low as compared to Examples 1 and 2.

### Test Example 2

Using the batteries of Examples and Comparative Example manufactured as described above, a change in discharge capacity according to discharge rate was tested.

In the test, the batteries manufactured in Examples and Comparative Examples as described above were left to stand for 2 days. Then, they were discharged at a current rate of 0.083 mA/cm², and charged under conditions of a current rate of 0.178 mA/cm², a charge voltage of 2.5 V and a charge capacity of 90 mAh and then left to stand at room temperature for 10 minutes. Next, they were stepwise discharged while the discharge rate was gradually increased from 0.178 mA/cm² to 1.78 mA/cm². Results of discharge capacity were expressed as percentages relative to a discharge capacity at a current rate of 0.178 mA/cm².

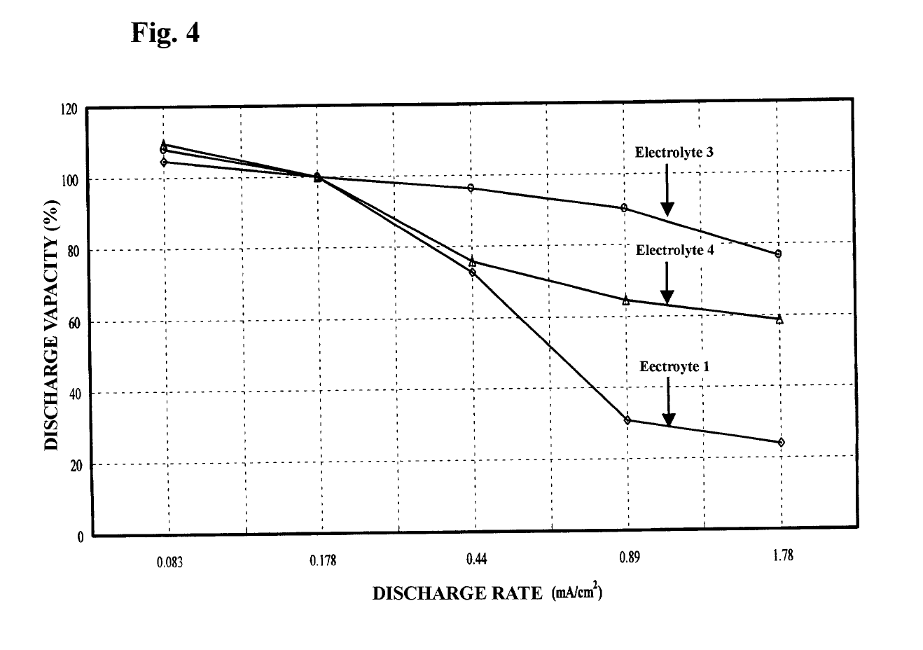

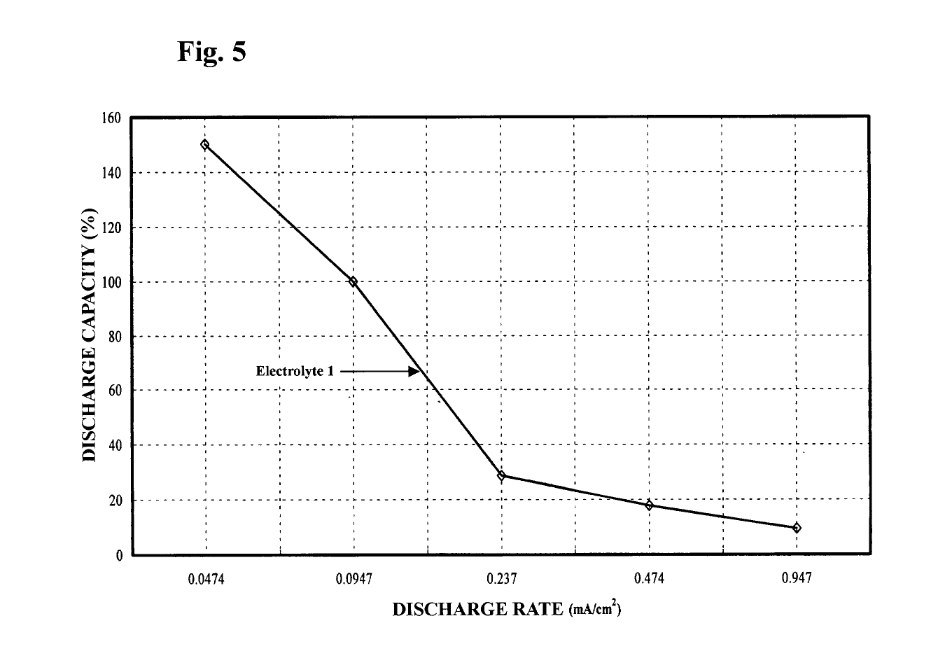

Tests were carried out for the batteries manufactured using Electrolytes 1, 3 and 4 in Example 1 and the battery manufactured using Electrolyte 1 in Comparative Example 1. Results are indicated in FIGS. 4 and 5, respectively.

From FIG. 4 showing the result of the test using the batteries manufactured in Example 1, it can be found that they exhibit the very excellent discharge rate even at high rate discharge. However, from FIG. 5 showing the result of the test using the battery manufactured in Comparative Example 1 exhibit the remarkably low discharge capacity at high rate discharge.

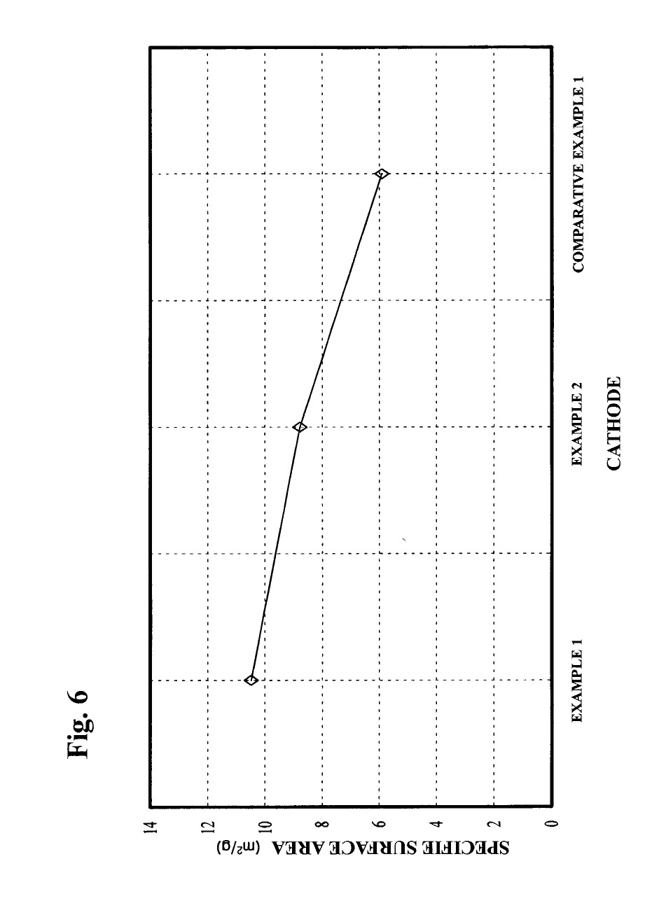

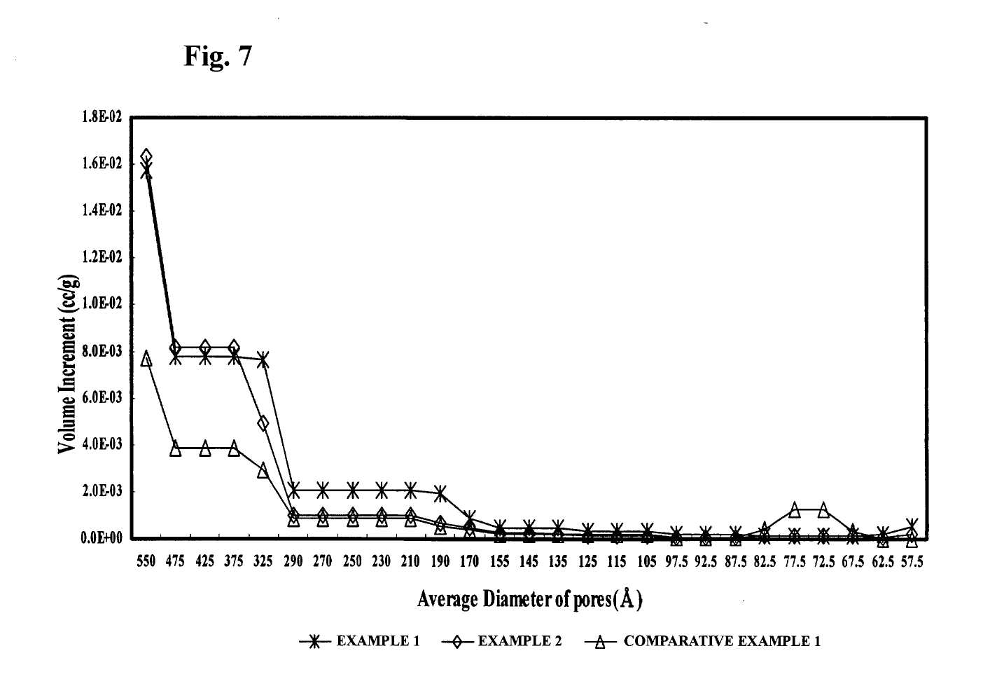

In order to understand causes for such results, the cathode mixture produced in Examples 1 and 2 and Comparative Example 1 were examined for specific surface area and pore distribution by a BET (Brunauer, Emmett and Teller) method. Results are shown in FIGS. 6 and 7. From FIG. 6, it can be found that the specific surface areas of the cathode mixtures manufactured according to Examples 1 and 2 are 10.5 m²/g and 9 m²/g, respectively, which are remarkably high as compared to 6 m²/g of Comparative Example 1.

Furthermore, in pore distribution, it was indicated that, in the cases of Examples 1 and 2, mesopores having a pore diameter of 300 to 600 Å were significantly developed as compared to the case of Comparative Example 1.

A preceding lithium-sulfur battery exhibits low sulfur availability and an insufficient characteristic at high rate discharge, since sulfur which is an active material is a non-conductive material. It is believed that, as a way for improving such disadvantages, properly controlling the size and distribution of pores within the electrode plate and increasing the specific surface area of the cathode material result in an increase in a contact area between the active material and the electrolyte so that the sulfur availability, the discharge capacity at high rate discharge, and the battery cycle life characteristic are significantly improved.

As apparent from the foregoing, the present invention provides the cathode for use in lithium secondary batteries, the method of manufacturing the cathode, the lithium-sulfur battery using the cathode and the method of manufacturing the lithium-second battery. According to the cathode of the present invention, various disadvantages with the lithium-sulfur batteries of the prior art, including low sulfur availability, dissolution and leakage of sulfur into electrolytes, deposition of lithium sulfide (Li₂S), and a reduction in discharge capacity at high rate discharge, are obviated. Furthermore, there is obviated a shortcoming that, when the existing binders are used, the choice of electrolytes is narrowly limited because of insufficient formation of pores within the cathode plate. In addition, there is obviated a disadvantage that, when highly viscose electrolytes are used, they are difficult to be penetrated into the electrode plate so that the availability of sulfur compounds is lowered and the high rate discharge characteristic is thus deteriorated.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A cathode for use in lithium-sulfur batteries, which contains a binder mixture where a thickener is mixed with polytetrafluoroethylene.

2. The cathode of claim 1, in which the thickener is one or more selected from the group consisting of carboxymethyl cellulose, polyvinyl alcohol, polyvinyl acetate, polyethylene oxide, polyacrylonitrile, polyvinyl pyrrolidone, alkylated polyethylene oxide, polyvinyl pyridine, crosslinked polyethylene oxide, polyvinyl ether, polymethyl methacrylate, polyvinylidene fluoride, copolymer of polyhexafluoropropylene and polyvinylidene fluoride, polyethylacrylate, polyvinyl chloride, and polystyrene.

3. A method of manufacturing a cathode for use in lithium-sulfur batteries, which comprises the steps of:
mixing 20 to 80% by weight of sulfur with 10 to 50% by weight of conductive carbon black relative to a cathode mixture for the manufacture of the cathode and then crushing the resulting mixture for 20 to 30 hours using a ball mill;
dissolving a thickener in a solvent mixture of water/ethanol (volume ratio of 9:1) at the amount of 0.1 to 20% by weight relative to the cathode mixture and adding a polytetrafluoroethylene emulsion (Asahi Glass Fluoropolymers Co., AD1; solid contents of 60% by weight) to the resulting solution at the amount of 0.1 to 20% by weight relative to the cathode mixture, thereby producing a binder solution;
introducing a solution of water/ethanol (volume ratio of 9:1) into the crushed sulfur and carbon black powders at a ratio of 176 g of powder per 200 g of solution, and adding a binder solution thereto in such a manner that the amount of polytetrafluoroethylene is 10 to 18% by weight relative to a final cathode plate and the amount of the thickener is 2 to 10% by weight relative to the final cathode plate, and then stirring the resulting mixture, thereby producing a cathode mixture slurry for the manufacture of the cathode; and
crushing the cathode mixture slurry for 10 to 15 hours using a ball mill, and uniformly applying the crushed slurry on both sides of aluminum foil to a thickness of 5 to 60 μm, and then drying the resulting aluminum foil at a temperature of 50 to 70° C. for 10 to 15 hours.

4. The method of claim 3, in which the thickener is one or more selected from the group consisting of carboxymethyl cellulose, polyvinyl alcohol, polyvinyl acetate, polyethylene oxide, polyacrylonitrile, polyvinyl pyrrolidone, alkylated polyethylene oxide, polyvinyl pyridine, crosslinked polyethylene oxide, polyvinyl ether, polymethyl methacrylate, polyvinylidene fluoride, copolymer of polyhexafluoropropylene and polyvinylidene fluoride, polyethylacrylate, polyvinyl chloride, and polystyrene.

5. A method of manufacturing a lithium-sulfur battery, which comprises the steps of:
mixing 20 to 80% by weight of sulfur with 10 to 50% by weight of conductive carbon black relative to a cathode mixture for the manufacture of the cathode and then crushing the resulting mixture for 20 to 30 hours using a ball mill;
dissolving a thickener in a solvent mixture of water/ethanol (volume ratio of 9:1) at the amount of 0.1 to 20% by weight relative to the cathode mixture and adding a polytetrafluoroethylene emulsion (Asahi Glass Fluoropolymers Co., AD1; solid contents of 60% by weight) to the resulting solution at the amount of 0.1 to 20% by weight relative to the cathode mixture, thereby producing a binder solution;
introducing a solution of water/ethanol (volume ratio of 9:1) into the crushed sulfur and carbon black powders at a ratio of 176 g of powder per 200 g of solution, and adding a binder solution thereto in such a manner that the amount of polytetrafluoroethylene is 10 to 18% by weight relative to a final cathode plate and the amount of the thickener is 2 to 10% by weight relative to the final cathode plate, and then stirring the resulting mixture, thereby producing a cathode mixture slurry for the manufacture of the cathode;
crushing the cathode mixture slurry for 10 to 15 hours using a ball mill, and uniformly applying the crushed slurry on both sides of aluminum foil to a thickness of 5 to 60 μm, and then drying the resulting aluminum foil at a temperature of 50 to 70° C. for 10 to 15 hours, thereby manufacturing a cathode plate; and
slitting the resulting cathode plate to have a predetermined size, and winding the slitted cathode plate together with an anode plate made of metallic lithium and a polyethylene sheet as a separator, in the form of a jellyroll, and mounting the winding into a battery case, and filling the battery case with an electrolyte, thereby assembling the lithium-sulfur battery.

6. The method of claim 5, in which the thickener is one or more selected from the group consisting of carboxymethyl cellulose, polyvinyl alcohol, polyvinyl acetate, polyethylene oxide, polyacrylonitrile, polyvinyl pyrrolidone, alkylated polyethylene oxide, polyvinyl pyridine, crosslinked polyethylene oxide, polyvinyl ether, polymethyl methacrylate, polyvinylidene fluoride, copolymer of polyhexafluoropropylene and polyvinylidene fluoride, polyethylacrylate, polyvinyl chloride, and polystyrene.

7. A lithium-sulfur battery, which is manufactured by the steps of:
mixing 20 to 80% by weight of sulfur with 10 to 50% by weight of conductive carbon black relative to a cathode mixture for the manufacture of the cathode and then crushing the resulting mixture for 20 to 30 hours using a ball mill;
dissolving a thickener in a solvent mixture of water/ethanol (volume ratio of 9:1) at the amount of 0.1 to 20% by weight relative to the cathode mixture and adding a polytetrafluoroethylene emulsion (Asahi Glass Fluoropolymers Co., AD1; solid contents of 60% by weight) to the resulting solution at the amount of 0.1 to 20% by weight relative to the cathode mixture, thereby producing a binder solution;
introducing a solution of water/ethanol (volume ratio of 9:1) into the crushed sulfur and carbon black powders at a ratio of 176 g of powder per 200 g of solution, and adding a binder solution thereto in such a manner that the amount of polytetrafluoroethylene is 10 to 18% by weight relative to a final cathode plate and the amount of the thickener is 2 to 10% by weight relative to the final cathode plate, and then stirring the resulting mixture, thereby producing a cathode mixture slurry for the manufacture of the cathode;
crushing the cathode mixture slurry for 10 to 15 hours using a ball mill, and uniformly applying the crushed slurry on both sides of aluminum foil to a thickness of 5 to 60 μm, and then drying the resulting aluminum foil at a temperature of 50 to 70° C. for 10 to 15 hours, thereby manufacturing a cathode plate; and
slitting the resulting cathode plate to have a predetermined size, and winding the slitted cathode plate together with an anode plate made of metallic lithium and a polyethylene sheet as a separator, in the form of a jellyroll, and mounting the winding into a battery case, and then filling the battery case with an electrolyte, thereby assembling the lithium-sulfur battery.

8. The lithium-sulfur battery of claim 7, in which the thickener is one or more selected from the group consisting of carboxymethyl cellulose, polyvinyl alcohol, polyvinyl acetate, polyethylene oxide, polyacrylonitrile, polyvinyl pyrrolidone, alkylated polyethylene oxide, polyvinyl pyridine, crosslinked polyethylene oxide, polyvinyl ether, polymethyl methacrylate, polyvinylidene fluoride, copolymer of polyhexafluoropropylene and polyvinylidene fluoride, polyethylacrylate, polyvinyl chloride, and polystyrene.
